(19) United States
(12) Patent Application Publication
(10) Pub. No.: US 2004/0195484 A1
(43) Pub. Date: Oct. 7, 2004

(54) Accessory hanger

(76) Inventor: Fiona Jaswant Singh Sheeran, Chapel Hill (AU)

Correspondence Address: Lisa M. Knight, Esq., Suite 4600, 140 Broadway, New York, NY, 10005, US

(21) Appl. No.: 10/826,569

(22) Filed: Apr. 16, 2004

(30) Foreign Application Priority Data
Oct. 10, 2001 (WO) PCT/GB01/04712

(51) Int. Cl. E04D 13/072; F16B 45/00

(52) U.S. Cl. 248/304; 248/914

(57) ABSTRACT

The present invention is an accessory hanger. In one embodiment this accessory hanger has an arm with first and second ends and first and second angles and a support base. The support base is rotatably coupled to the first end of the arm. The length of first end of the arm is at least substantially the same as that of the support base. This feature provides the necessary support and balance to allow the support base to remain stable on a flat when weight is applied to the arm in the downward direction. This accessory hanger is a compact, portable device that may be used to hang handbags, umbrellas, shopping bags, jackets and other items from restaurant table tables or any other suitable flat surface. This accessory hanger is made even more compact and portable when the arm includes has a coupling means such as a hinge that allows it to be folded or a screw connection that allows the arm to be disassembled. This accessory hanger is made adjustable when the arm includes a coupling means with telescoping action that allows the length of the arm to be extended to accommodate the various thicknesses of the table on which the hanger is attached. Both the support base and the arm may be decoratively constructed to provide a fashionable appearance.

### CROSS-REFERENCE TO RELATED APPLICATIONS

This claims the benefit of International Patent Application No. PCT/GB01/04712, filed on Oct. 10, 2001.

### BACKGROUND OF THE INVENTION

1. Field of the Invention

The present invention relates to a compact-sized hanger that can be used to safely and conveniently hang accessories such as handbags, umbrellas, jackets, other clothing, bags with handles or straps and the like from table tops or other flat surfaces.

2. Description of the Prior Art

Prior art attempts at devising a compact hanger includes, the Lo U.S. Pat. No. 5,594,419, which discloses a table-edge hanger having a hook for hanging a personal item such as a purse or a jacket and a base for placing against the edge of the table. In this device the hook is connected to one side of the base and a decorative attachment is attached to the top side of the base. Another patent is the Creed U.S. Pat. No. 5,094,417 discloses a device for receiving, hanging and supporting purses, handbags and other strap carried containers on the edge of a table, desk or other support. This device includes a first normally horizontal arm, second normally vertical arm, a third substantially normally horizontal arm and a C-shaped hook member is pivotally fixed at one upper end to the underside of the third arm. The Schultz U.S. Pat. No. 4,194,719 discloses a hanger for women purses and handbags that consists of a pair of elongated hinged support arms with a rubber semi-cylindrical bail mounted at the distal end of one of the arms, and which some means at the distal end of the other arm from with a purse or other article may be suspended. The two arms are disposed essentially at a 90 degree angle relative to each other. A hinge means is used to couple the first arm to the second arm. Another U.S. Pat. No. 4,118,001 discloses a handbag holder that is designed to form a compact, elongated box that is open on the front. The holder comprises a longer support arm and a shorter hook arm can fit snuggly within the box when folded.

One disadvantage of some prior art hangers is that they tend to be unstable when weight such as that of a hand bag is place on its support end. This instability causes the base of the hanger that sits on a flat surface such as a table to lift up on the side that is not attached to the arm. The primary reason for this is that when the arm of the hanger is attached to one side of the base the weight of a hanging item is not evenly distributed across the base and results in this type of undesirable instability or slippage.

Another disadvantage of the prior art is that the length of the arm is not adjustable. The inability for the arm to be adjusted prevents such hangers from being used in situations where a flat surface such as table in a restaurant may be thicker than usual. In this situation, the hanger cannot be used because it cannot properly be adjusted to sit on the table top so that an item, such as a handbag or jacket can hang from it as intended.

Another disadvantage of some of the prior art hangers, is that they are designed in a complicated manner and as a result requires a more complicated and costly manufacturing process.

### SUMMARY OF THE PRESENT INVENTION

Accordingly, the object of the present invention is to eliminate some of the disadvantages found in the prior art and to provide an accessory hanger that is less complicated and costly to manufacture. Another object of the present invention is to provide a hanger design that is balanced such that the weight of a handbag, purse, umbrella, etc. does not cause it to become unbalanced, the base to lift off of the table surface on one side or the base to slide off of the table top or surface.

Another object of the present invention is to provide an accessory hanger that has arm that can accommodate various thicknesses associated with a variety of different table or flat surfaces. Another object of the present invention is to provide a light weight and compact hanger that is easily stowed, transportable and durable. Another object of the present invention is to provide its user with a more convenient and fashionable manner to secure valuable items such as handbags, other accessories or clothing.

One embodiment of the present invention is accessory hanger for conveniently hanging items from flat surfaces that includes a support base having an internal receiving portion that at least substantially transverses the support base, a one piece arm having a first end and a second end, a first angle and a second angle. The first end is inserted into the receiving portion so that it rotatably engages the support base. The accessory hanger also includes an attachment means that engages and secures the first end to the support base.

Another embodiment of the present invention is an accessory hanger for conveniently hanging items from flat surfaces that includes a support base having an internal cylindrically shaped hollow column that at least substantially transverses the support base. It also includes a one piece arm having a first end and a second end, a first angle and a second angle, wherein the first end further comprises spiral grooves and wherein the first end is inserted into the hollow column so that it rotatably engages the support base and an attachment means that it engages and secures the first end to the support base.

Another embodiment of the present invention is an accessory hanger for conveniently hanging items from flat surfaces that includes a support base having an internal cylindrically shaped hollow column that at least substantially transverses the support base and a two piece arm having a first section and a second section. The first section has a first end and a second end and the second section has a first end and a second end. The first end of the first section further comprises spiral grooves and is inserted into said hollow column so that it rotatably engages the support base. The second end of the first section further includes part of a coupling means that engages and secures the first section to the second section. The first end of the second section further includes another part of the coupling means that engages and secures the second section to the first section and an attachment means that engages and secures the first end of the first section to the support base.

The second end or bottom end of the arm is disposed in an upward direction so that the second or bottom end will support hanging items. Additionally, the first end is substantially the same length as the support base.

Preferably, the support base one inch or greater across. The support base may be made of precious or non-precious metals, stone, resin, glass, plastic, decorative material or the like.

The support base may be plain or decoratively shaped in various forms such a letter, star, insignia or some other ornamental shape. Additionally, the support base may be engraved, embossed or contain ornamental items within. The bottom surface of the support base may be covered with a protective material to protect the base and any surface upon which it is placed.

The arm of the accessory hanger may also be made of decorative material and in a decorative manner. It may have a cross-section that is substantially rounded, rectangular or any slope.

The accessory hanger has several various types of attachment means. One is designed so that the first end has spiral grooves and the walls of the receiving portion or hollow column of the support base has corresponding grooves that rotatably secures the first end of the arm to the support base when the first end is screwed into the base.

Another attachment means includes a nut with internal grooves that correspond to the grooves in the first end or top end of the arm so that the first end of the arm is secured to the support base. Another attachment means includes a first arm that has a nail-like head. This nail-like head provides a means by which the first or top end of the arm is secured to the support base.

The above advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The features and advantages of the present invention will become apparent in the following detailed description and accompanying drawings in which like references denote like or corresponding parts, in which:

FIG. 1 shows an accessory hanger having a rectangular base that is rotated in a vertical direction such that the top of the base is shown.

FIG. 2 shows an accessory hanger having a rectangular base disposed on a flat surface such as a table top.

FIG. 3 shows a top side perspective of the rectangular base shown in FIGS. 1 and 2.

FIG. 4 shows an angular view of the accessory hanger having a rectangular base that is rotated in a vertical direction such that the top of the base is shown and a hinged arm.

FIG. 5A shows a top view of a decorative support base that could be embedded with ornamental items, engraved embossed or cut away.

FIG. 5B shows a top view of a decorative rectangular support base that could be embedded with ornamental items, engraved embossed or cut away.

FIG. 5C shows a top view of a decorative star-shaped support base that could be embedded with ornamental items engraved, embossed or cut away.

FIG. 6A shows a side view of an arm having first and second ends

FIG. 6B shows an angular front view of a two piece arm having first and second sections, where each section has first and second ends. This two piece are also has a hinged coupling means that connects the first and second sections.

FIG. 6C shows an angular side view of a two piece arm having first and second sections, where each section has first and second ends. The two piece arm also has a coupling means having grooves that allows the first section and second section to be assembled and disassembled.

FIG. 6D shows an angular side view of a two piece arm having first and second sections, where each section has first and second ends. This two piece arm also has a coupling means that uses a telescoping mechanism with or without a spring to allow for adjusting the length of the arm.

FIG. 6E shows a cross sectional view of a spring loaded telescoping arm and support base shown in FIG. 6D.

FIG. 6F shows a cross sectional view of a telescoping arm without a spring shown and support base in FIG. 6D.

FIG. 7A shows a side view of an arm having a grooved first end that fits into the receiving portion of the support base and is secured by a correspondingly grooved nut. A cross sectional view of the support base and nut are also shown.

FIG. 7B shows a side view of an arm having a grooved first section that fits into the receiving portion of a support base. The receiving end has grooves that correspond to the grooves on the first end so that the first end and support base can be attached without use of a nut.

FIG. 7C shows a side view of an arm having an attachable nail head like tip that allows the first end and support base to be attached.

### DETAILED DESCRIPTION

This invention is an everyday item that both men and women will find useful, fashionable, durable and affordable. This accessory hanger allows items such as handbags to hang from a hanger that is attached to a support base which is positioned on a flat surface such as a table. This accessory hanger solves the problem of where to hang or stow your bag, other accessories or clothing items safely, securely and discretely while keeping it close at hand. Using an accessory hanger also allows the user to keep their hands free while dining in restaurants or other places that carrying accessories at times becomes tiresome.

FIG. 1 shows the top view one embodiment of accessory hanger 100 that includes one piece arm 20 having angular ends 23 and 24 and rectangular base 10. As can be seen from this figure, accessory hanger 100 may be designed simply so as to minimize manufacturing costs. First end 21 of arm 20 is inserted in to support base 10 using some type of an attachment means. Second end 22 of arm 20 is angled in an upward position so as to support items such as handbags or jackets that may be placed on it. Angular ends 23 and 24 may be 90 degrees or less.

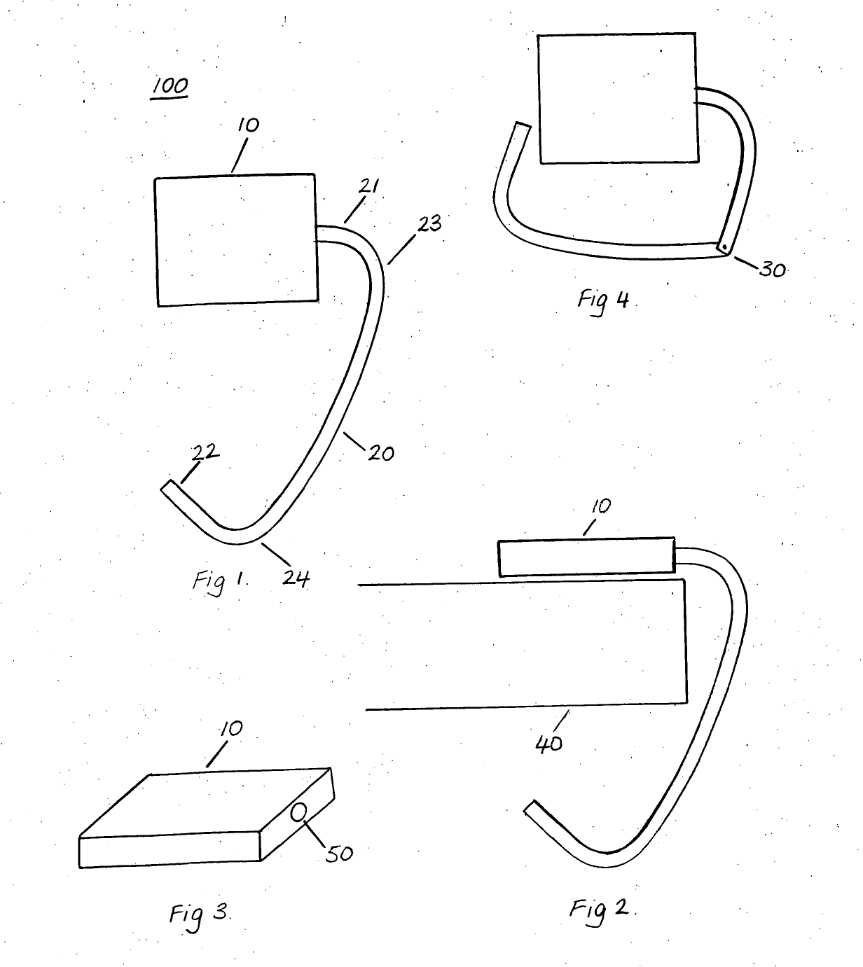

FIG. 2 shows a side view of accessory hanger 100 shown in FIG. 1. As seen from this view, support base 10 is designed so that it can be placed on flat surface 40 and allow arm 20 to hang in a downward position.

FIG. 3 shows a side top view of support base 10 that is shown in FIGS. 1 and 2. Preferably, support base 10 is constructed using precious and non-precious metals. However, support base 10 may also be constructed from plastic, ceramic, metal alloys, wood, resin, glass, magnetic materials or the like or a combination thereof.

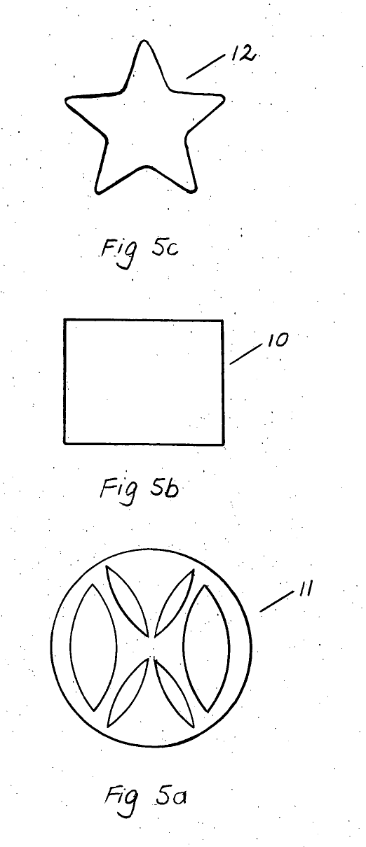

FIG. 4 shows an angular side view of accessory hanger 100 with two piece hinged arm 25 in its collapsed or folded position.

FIGS. 5A-5C shows the top view of various types of support bases. These figures show that support base 10 may also be constructed to be fashionable and very ornamental. As seen in FIG. 5A, support base 11 may be constructed in a decorative manner to have items such as precious and non-precious gems or other ornamental items embedded within. Similarly, support base 11 may be constructed so that it has decorative engraving, embossing or cut away pieces on the top surface and side surfaces. Support base 11 may also be manufactured in a decorative shape. These shapes include but are not limited to circular shape 11 in FIG. 5A, rectangular shape 11 in FIG. 5B and star-shaped base 12 in FIG. 5C. Support base 12 may be constructed so that it has decorative engraving, embossing or cut away pieces on the top surface and side surfaces. Clearly, support bases may take a wide variety of different forms. As a result, it is relatively easy to manufacture an ornamental accessory hanger that would appeal to a wide variety of different fashion tastes.

In one embodiment, the bottom of support base 10, 11 or 12 may be constructed so that it is covered with a protective material (not shown in the figures) that prevents the support base from getting damaged or scratched when it is placed on surfaces. The protective material also acts to prevent the flat surfaces or table tops from also being damaged by the support base if the support base is constructed using a hard material. The protective material may be made from natural or man-made fabrics, felt, rubber, leather or the like. Preferably, support base 10, 11, and 12 are constructed to be at least one inch in length.

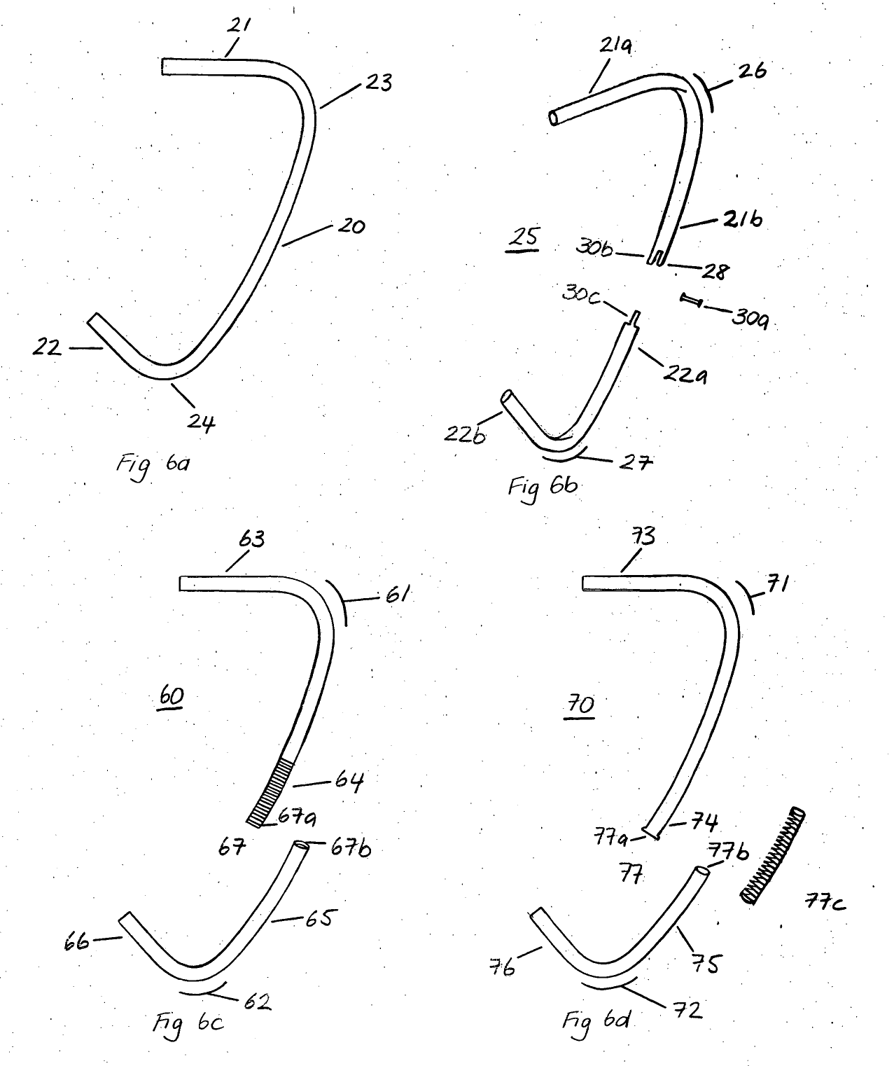

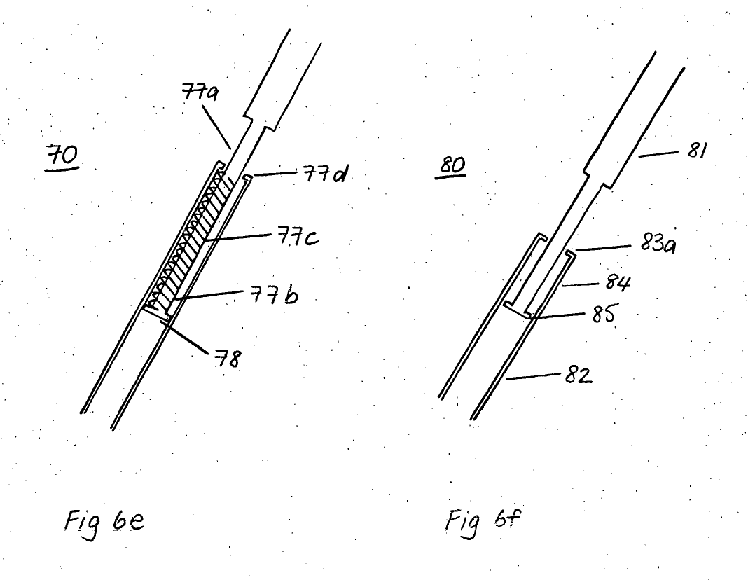

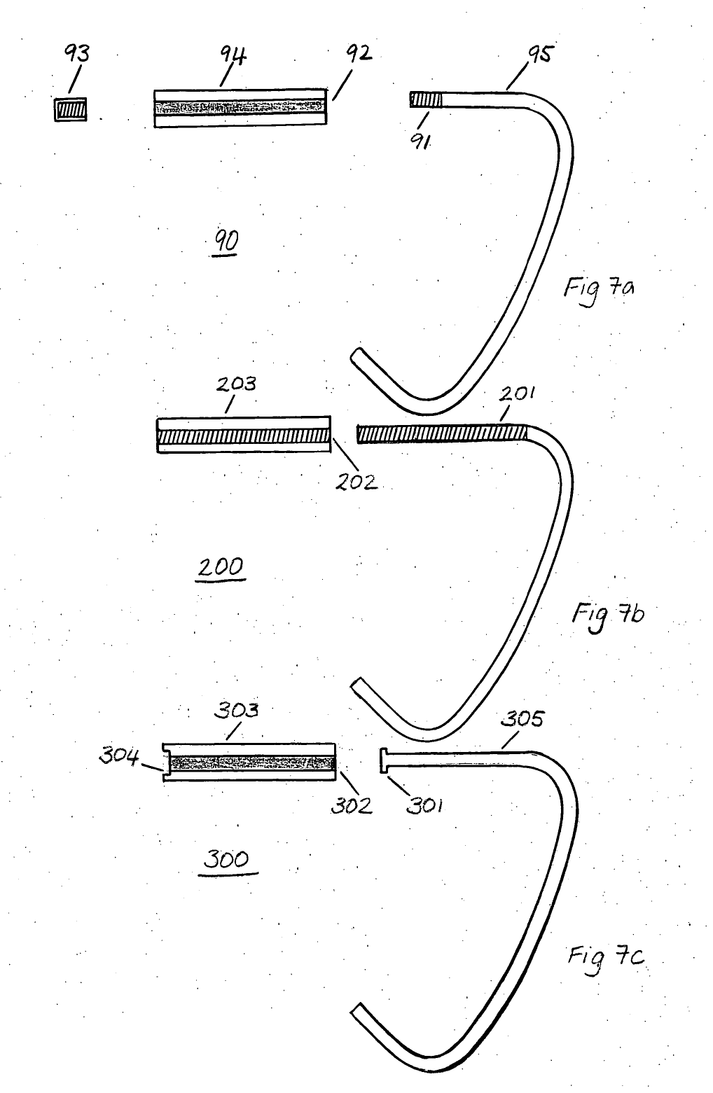

FIGS. 6A to 6F show various embodiments of accessory hanger arm 20. FIG. 6A is a side view of one piece arm 20 having a first or top end 21 and second or bottom end 22. Also shown in FIG. 6A, there are two angles that give arm 20 in this embodiment a curved shape. It can also be seen from FIGS. 6A-6D that the cross-section of arm 20 may be roundly shaped. However, the cross-section of arm 20 may also have a rectangular shape (not shown in the Figures). For the rectangular shaped arm, the first end of the arm may have to be rounded so that it could be fitted into cylindrically-shaped receiving portion 50 of support base 10 in FIG. 3. Receiving portion 50 of support base 10, 11 and 12 is discussed below in FIGS. 7A-7C.

FIG. 6B shows an angular front/side view of two piece arm 25 with coupling means 30 that connects first and second sections 26 and 27 of arm 25. More specifically, it hingedly connects first end 22a of second section 27 to second end 21b of first section 26. In the embodiment shown in FIG. 6B, the hinge uses pin 30a. Pin 30a is inserted through holes in tip portions 30b and 30c of first end 22a of second section 27 and second end 21b of first section 26. This is a conventional hinge. However, most other hinge constructions may also be used in the two piece arm embodiments. FIG. 4 shows an angular side view of accessory hanger 100 with two piece hinged arm 25 in its collapsed or folded position.

FIG. 6C shows an angular side view of two piece arm 60 having first and second sections 61 and 62, where each section has first and second ends 63, 64, 65 and 66, respectively. Two piece arm 60 also has coupling means 67 has corresponding grooves that allows first section 61 and second section 62 to be assembled and disassembled. First end 65 of second section 62 has cylindrical hollow column or receiving portion 67b into which coupling means 67a of first section 61 is screwed. The accessory hanger embodiment represented by this figure is extremely compact and portable. As with all other embodiments, preferably accessory hanger 100 will be carried or stowed in a small carrying case.

FIG. 6D shows an angular side view two piece arm 70 having first and second sections 71 and 72, where each section has first and second ends 73, 74, 75 and 76, respectively. Two piece arm 70 also has coupling means 77 that uses a telescoping mechanism with spring 77c or without to allow for adjusting and extending the length of arm 70.

FIG. 6E shows a cross sectional view of spring loaded telescoping arm 70 as shown in FIG. 6D. More specifically, this figure shows spring loaded telescoping arm 70 when it is being pulled in a downward direction or being weighted down by an object such as a handbag. In this configuration, spring 77c will expand or be caused to elongate when weight is applied to accessory hanger arm 70. When the weight is removed spring 77c recoils and arm 70 returns to its normal compact position. This embodiment also includes protrusions 78 on the second end 74 of first section 71 it engages protrusion 77d to prevent first section 71 of arm 70 from becoming completely disconnected from second section 72. Designing accessory hanger 100 to have an adjustable arm that extends in length allows hanger 100 to be positioned on a wider variety of surfaces having varying degrees of thickness. The prior art hangers were much more limited in this respect because they did not have extendable arms.

FIG. 6F shows a cross sectional view of a telescoping arm without spring 77c which is shown in FIG. 6D. This embodiment uses a similar telescoping mechanism to expand the length of the arm. Like the telescoping mechanism shown in FIG. 6D, this embodiment has an arm that extends its length when weight is applied to the lower portion or second section of the arm. However, due to the absence of the spring, it will not automatically return to its normal compact position. It could be manually closed or moved to so that it returns to its normal more compact length. This embodiment also has protrusions 83a on second section 82 that engages with protrusion 85 on first section 81 to prevent first end 84 of second section 82 of arm 80 from becoming completely disconnected from first section 81.

Preferably all of the arm embodiments shown in FIGS. 6A-6F are made from precious or non-precious metals. However, of course, additional materials such as plastic or other synthetic materials could be used. Arms may be constructed so that they are at least substantially the same length as the support base that they will be inserted into.

FIG. 7A shows a side view of arm 90 having grooved first end tip 91 that fits into receiving portion 92 of support base 94 and is secured by correspondingly grooved nut 93. A cross sectional view of support base 94 and nut 93 are also shown. In this embodiment, first end 95 of arm 90 is inserted into receiving portion 92 or cylindrical hollow column 92 in support base 94. Arm 90 is at least substantially the same length as support base 94 so when it is inserted all the way to the other side of support base 94 nut 93 may be screwed onto grooved tip 91 of first end 95 of arm 90 so that arm 90 will be securely and rotatably attached to support base 94.

FIG. 7B shows a side view of arm 200 having grooved first end 201 that fits into grooved receiving portion 202 or cylindrical hollow column 202 of support base 203. Receiving portion 202 has grooves that correspond to the grooves on first end 201 so that first end 201 and support base 203 can be securely and rotatably attached without use of a nut or a nut like attachment means.

FIG. 7C shows a side view of one piece arm 300 having an attachable nail head-like tip 301 that allows first end 305 and support base 303 to be attached. In this embodiment head 301 is attached to first end 305 of arm 300 after first end 305 is inserted into cylindrically hollow column 302 in support base 303. Nail head-like tip 301 may be attached to first end 305 of arm 300 either by soldering it on or by some other similar process of attachment. Once head 301 is attached to first end 305 it remains securely within support base 303 in the receding portion 304. Hollow column 302 in support base 303 is designed so that it will not allow first end 305 of arm 300 to slip out from support base 303. Any other suitable attachment means may be used to secure the first end of the arm to the support base.

Preferably, receiving portion 50 may be cylindrically-shaped. However, receiving portion 50 may also be rectangular-shaped as well. A support base have a rectangular-shaped receiving portion may require that the first end of the arm be designed so that it allows the arm to move pivotally around its axis. The arm may be made in a decorative manner by using texturized or engraved materials, colored or the like.

As was shown in the figures and description, this accessory hanger has several embodiments that make it very useful. It has a variety of support bases, arms and attachment means that are interchangeable. Although certain preferred embodiments of this invention have been described, the spirit and scope of the invention is not limited to what is described above.

What is claimed is:

1. An accessory hanger for conveniently hanging items from flat surfaces, comprising:
a support base having a receiving portion that at least substantially transverses said support base; and
an arm having a first end and a second end, a first angle and a second angle, wherein said first end is inserted into said receiving portion so that it rotatably engages said support base.

2. An accessory hanger for conveniently hanging items from flat surfaces, comprising:
a support base having an internal cylindrically shaped hollow column that at least substantially transverses said support base;
an arm having a first end, a first angle and a second angle, wherein said first end that includes spiral grooves inserted into said hollow column so that it rotatably engages said support base; and
an attachment means that engages and secures said first end to said support base.

3. The accessory hanger of claim 2, wherein said arm has a second end disposed in an upward direction so that said second end will support items hanging therefrom.

4. The accessory hanger of claim 2, wherein said first end is substantially the same length as said support base.

5. The accessory hanger of claim 2, wherein said support base is made of a precious metal.

6. The accessory hanger of claim 2, wherein said support base is made of a non-precious metal.

7. The accessory hanger of claim 2, wherein said support base is decoratively shaped.

8. The accessory hanger of claim 2, wherein said support base is decoratively shaped like a letter.

9. The accessory hanger of claim 2, wherein said support base is decoratively engraved.

10. The accessory hanger of claim 2, wherein said support base is decoratively embossed.

11. The accessory hanger of claim 2, wherein said support base contains embedded items.

12. The accessory hanger of claim 2, wherein the bottom surface of said support base is covered with a protective material.

13. The accessory hanger of claim 2, wherein said support base contains cut away pieces.

14. The accessory hanger of claim 2, wherein the cross-section of said arm is substantially rounded.

15. The accessory hanger of claim 2, wherein the cross-section of said arm is substantially rectangular.

16. The accessory hanger of claim 2, wherein said attachment means comprises said first end having spirally grooves and the walls of said hollow column of said support base having corresponding grooves that rotatably secures said first end of said arm to said support base.

17. The accessory hanger of claim 2, wherein said attachment means comprises a nut with internal grooves that correspond to the grooves in said first end so that said first end of said arm is secured to said support base.

18. The accessory hanger of claim 2, wherein said attachment means comprises said first arm having a nail-like head so that said first end of said arm is secured to said support base.

19. An accessory hanger for conveniently hanging items from flat surfaces, comprising:
a support base having an internal cylindrically shaped hollow column that at least substantially transverses said support base;
an arm with at least two pieces having a first section and a second section, wherein said first section having a first end and a second end and said second section has a first end and a second end;
said first end of said first section further comprises spiral grooves and is inserted into said hollow column so that it rotatably engages said support base and wherein said second end of said first section further comprises part of a coupling means that engages and secures said first section to said second section;
said first end of said second section further comprises another part of said coupling means that engages and secures said second section to said first section; and
an attachment means that engages and secures said first end of said first section to said support base.

20. The accessory hanger of claim 19, wherein said first end of said first section is substantially the same length as said support base.

21. The accessory hanger of claim 19, wherein said second end of said second section of said arm is disposed in an upward direction so that said second section will support items hanging therefrom.

22. The accessory hanger of claim 19, wherein said first section and second section are angular.

23. The accessory hanger of claim 19, wherein said attachment means comprises said first end of said first second first having spirally grooves and the walls of said hollow column of said support base having corresponding grooves that rotatably secures said first end of said first section of said arm to said support base.

24. The accessory hanger of claim 19, wherein said attachment means comprises a nut with internal grooves that correspond to the grooves in said first end of said first section so that said first end of said first section is secured to said support base.

25. The accessory hanger of claim 19, wherein said attachment means comprises said first end of said first section having a nail-like head so that said first end of said first section of said arm is secured to said support base.

26. The accessory hanger of claim 19, wherein said coupling means comprises said second end of said first section having spiral grooves and said first end of said second section having a cylindrical hollow column having corresponding grooves into which the second end of said first section end is screwed.

27. The accessory hanger of claim 19, wherein said coupling means comprises a hinge that allows said arm to be folded so that said hanger is more compact and easily portable.

28. The accessory hanger of claim 19, wherein said coupling means that extends the length of the arm in a telescoping manner so that said accessory hanger can be adjusted to accommodate various thicknesses of the surfaces on which said accessory hanger is position.

29. The accessory hanger of claim 19, wherein said coupling means that extends the length of the arm in a telescoping manner using a spring so that said accessory hanger can be extended to accommodate various thicknesses of the surfaces on which said accessory hanger is position and so that when said accessory hanger reverts back to its original length when removed from a thick surface.

30. The accessory hanger of claim 19, wherein said arm is made is a decorative manner.
